(19) United States
(12) Patent Application Publication
(10) Pub. No.: US 2008/0020896 A1
(43) Pub. Date: Jan. 24, 2008

(54) Control apparatus for vehicular automatic transmission and method of controlling vehicular automatic transmission

(75) Inventor: Hirofumi Kamishima, Toyota-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOYOTA JIDOSHA KABUSHIKI KAISHA

(21) Appl. No.: 11/826,402

(22) Filed: Jul. 16, 2007

(30) Foreign Application Priority Data
Jul. 20, 2006 (JP) 2006-198552

(51) Int. Cl. F16H 61/20; G06F 17/00

(52) U.S. Cl. 477/117; 701/58

(57) ABSTRACT

In a control apparatus for a vehicular automatic transmission and a method of controlling a vehicular automatic transmission, a brake operation amount by which the brake of a vehicle is operated is detected, and a neutral control is executed to decrease an engagement pressure for a friction engagement element of the automatic transmission, when a shift lever is in a forward gear position, an accelerator pedal is not operated, the brake is operated, and the vehicle is stopped. The engagement pressure for the friction engagement element is increased when the detected brake operation amount decreases during the neutral control.

### INCORPORATION BY REFERENCE

The disclosure of Japanese Patent Application No. 2006-198552 filed on Jul. 20, 2006, including the specification, drawings and abstract is incorporated herein by reference in its entirety.

### BACKGROUND OF THE INVENTION

1. Field of the Invention

The invention relates to a control apparatus for a vehicular automatic transmission and a method of controlling a vehicular automatic transmission. More specifically, the invention relates to the control of an engagement pressure for a friction engagement element during a neutral control.

2. Description of the Related Art

In a conventional vehicle provided with an automatic transmission, a neutral control is executed to decrease an engagement pressure for a friction engagement element, such as a forward clutch, to improve fuel efficiency when the vehicle is stopped.

Japanese Patent Application Publication No. 2005-41313 (JP-A-2005-41313) describes a vehicle start control apparatus that appropriately executes a control for starting a vehicle based on the operational state of the brakes of the vehicle when the neutral control is being executed, or when the neutral control ends. The vehicle start control apparatus described in the above patent publication controls the vehicle provided with an automatic transmission that includes an engagement element that is engaged when the vehicle starts. When a shift lever is in a forward gear position, and the state of the vehicle satisfies a predetermined condition and the vehicle stops, the neutral control is executed to disengage the engagement element. The vehicle start control apparatus includes a detection portion, and a control portion. The detection portion detects the operational state of the brakes of the vehicle. The control portion controls the engagement of the engagement element based on the operational state of the brakes detected by the detection portion, when the neutral control ends.

In the vehicle start control apparatus described in the above patent publication, when the neutral control ends and a normal control is restarted while there is still a residual brake pressure, the control portion decreases an initial engagement pressure for the engagement element so that the engagement element is gradually engaged. This prevents the engagement element from being quickly engaged when the driver still depresses the brake pedal. Therefore, occurrence of an engagement shock is prevented when the neutral control ends. Further, the vehicle appropriately starts. For example, when the driver quickly releases the brake, the control portion quickly engages the engagement element. Thus, when the driver wants to quickly reduce the braking force to quickly start the vehicle, the engagement element is quickly engaged. This prevents the driver from feeling that the vehicle starts slowly when the neutral control ends. Thus, good starting performance is achieved.

However, because the above-described vehicle start control apparatus quickly engages the friction engagement element when the driver quickly releases the brake, the engagement shock increases when the neutral control ends.

### SUMMARY OF THE INVENTION

The invention provides a control apparatus for a vehicular automatic transmission that decreases an engagement shock when a neutral control ends.

A first aspect of the invention relates to a control apparatus for a vehicular automatic transmission, which includes a detector, and a controller. The detector detects a brake operation amount by which the brakes of a vehicle are operated. The controller executes a neutral control to decrease an engagement pressure of a friction engagement element in the automatic transmission, when a shift lever is in a forward gear position, the accelerator pedal is not operated, the brake is operated, and the vehicle is stopped. The controller increases the engagement pressure for the friction engagement element when the brake operation amount detected by the detector decreases during the neutral control.

Another aspect of the invention relates to a method of controlling a vehicular automatic transmission. The method includes detecting the brake operation amount by which the brake of a vehicle is operated during a neutral control; executing the neutral control to decrease the engagement pressure for a friction engagement element of the automatic transmission, when a shift lever is in a forward gear position, an accelerator pedal is not operated, the brake is operated, and the vehicle is stopped; and increasing the engagement pressure for the friction engagement element when the detected brake operation amount decreases during the neutral control.

In the above-described control apparatus and method, when the detected brake operation amount decreases during the neutral control, the engagement pressure for the friction engagement element is increased. Thus, the engagement pressure is increased before the neutral control ends. Therefore, the engagement pressure need not be quickly increased to quickly restart a normal control when the neutral control ends. This decreases an engagement shock when the neutral control ends.

Another aspect of the invention relates to a control apparatus for a vehicular automatic transmission, which includes a controller and a measurement device. The controller executes a neutral control to decrease the engagement pressure for a friction engagement element of the automatic transmission, when a shift lever is at a forward gear position, an accelerator pedal is not operated, the brake of a vehicle is operated, and the vehicle is stopped. The measurement device measures the elapsed time after start of the neutral control. The controller increases the engagement pressure for the friction engagement element when the elapsed time measured by the measurement device exceeds a predetermined time during the neutral control.

Another aspect of the invention relates to a method of controlling a vehicular automatic transmission, which includes executing a neutral control to decrease an engagement pressure for a friction engagement element of the automatic transmission when a shift lever is at a forward gear position, an accelerator pedal is not operated, the brake of a vehicle is operated, and the vehicle is stopped; measuring an elapsed time after start of the neutral control; and increasing the engagement pressure for the friction engagement element during the neutral control when the elapsed time after start of the neutral time exceeds a predetermined time.

In the above-described control apparatus and method, when the elapsed time after the start of the neutral control exceeds a predetermined time, the engagement pressure for the friction engagement element is increased. Thus, when the elapsed time after the start of the neutral control is long, and therefore, there is a high possibility that the vehicle will start, the engagement pressure is increased before the neutral control ends. Therefore, the engagement pressure need not be quickly increased to quickly restart the normal control when the neutral control ends. This decreases the engagement shock when the neutral control ends.

### BRIEF DESCRIPTION OF THE DRAWINGS

The features, advantages thereof, and technical and industrial significance of this invention will be better understood by reading the following detailed description of example embodiments of the invention, when considered in connection with the accompanying drawings, in which:

FIG. 1 is a schematic configuration diagram showing the powertrain of a vehicle;

FIG. 2 is a skeleton diagram showing the planetary gear unit of an automatic transmission;

FIG. 3 is a diagram showing an operation table of the automatic transmission;

FIG. 4 is a diagram showing the hydraulic circuit of the automatic transmission;

FIG. 5 is a diagram showing a brake system;

FIG. 6 is a function block diagram of an ECT_ECU according to a first embodiment of the invention;

FIG. 7 is a first flow chart showing the control structure of a program executed by the ECT_ECU according to the first embodiment of the invention;

FIG. 8 is a second flow chart showing the control structure of the program executed by the ECT_ECU according to the first embodiment of the invention;

FIG. 9 is a timing chart showing changes in a master cylinder pressure and an engagement pressure according to the first embodiment of the invention;

FIG. 10 is a function block diagram of an ECT_ECU according to a second embodiment of the invention;

FIG. 11 is a first flowchart showing the control structure of a program executed by the ECT_ECU according to the second embodiment of the invention;

FIG. 12 is a second flowchart showing the control structure of the program executed by the ECT_ECU according to the second embodiment of the invention;

FIG. 13 is a timing chart showing changes in the master cylinder pressure and the engagement pressure according to the second embodiment of the invention;

FIG. 14 is a function block diagram of an ECT_ECU according to a third embodiment of the invention;

FIG. 15 is a flowchart showing the control structure of a program executed by the ECT_ECU according to the third embodiment of the invention; and

FIG. 16 is a timing chart showing changes in the master cylinder pressure and the engagement pressure according to the third embodiment of the invention.

### DETAILED DESCRIPTION OF THE EXAMPLE EMBODIMENTS

Hereinafter, embodiments of the invention will be described with reference to the drawings. In the following description, the same and corresponding components are denoted by the same reference numerals, and have the same names and the same functions. Therefore, the detailed description thereof will not be repeated.

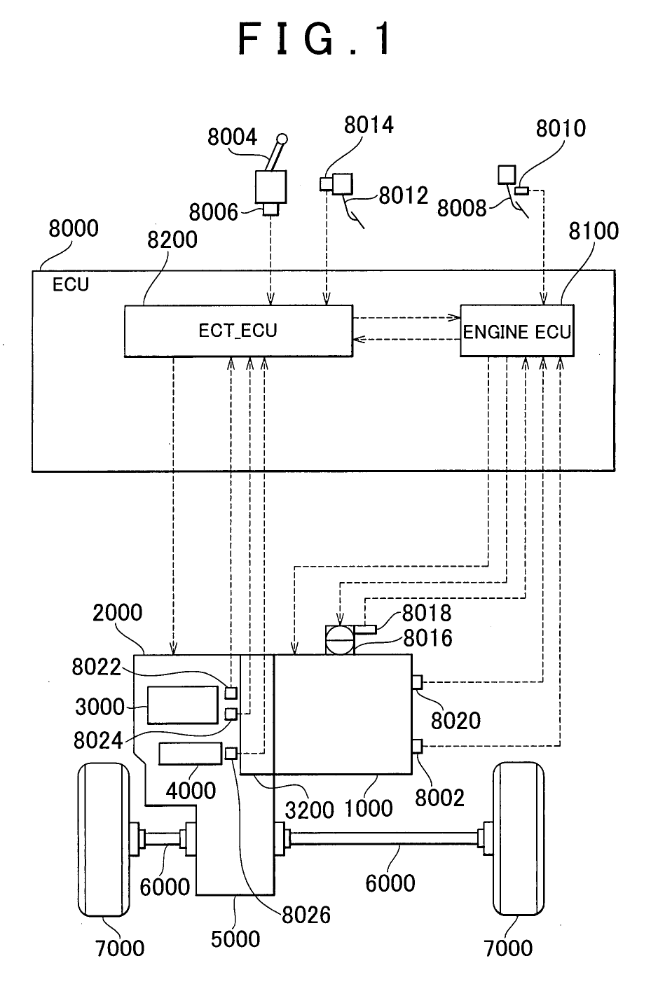

A vehicle provided with a control apparatus according to a first embodiment of the invention will be described with reference to FIG. 1. The vehicle is a front-engine front-drive vehicle. The control apparatus according to the invention may be provided in a vehicle other than the front-engine front-drive vehicle.

The vehicle includes an engine 1000, an automatic transmission 2000; a planetary gear unit 3000 that constitutes a part of the automatic transmission 2000; a hydraulic circuit 4000 that constitutes a part of the automatic transmission 2000; a differential gear 5000; a drive shaft 6000; front wheels 7000; and an ECU (Electronic Control Unit) 8000. The control apparatus according to the embodiment may be implemented, for example, by executing a program stored in the ROM (Read Only Memory) of the ECU 8000.

The engine 1000 is an internal combustion engine in which mixture of air and fuel injected from an injector (not shown) is burned in the combustion chamber of each cylinder. A piston is pushed down in the cylinder by combustion, and thus a crankshaft is rotated.

The automatic transmission 2000 is connected to the engine 1000 via a torque converter 3200. When a desired gear is selected in the automatic transmission 2000, the rotational speed of the crankshaft input to the automatic transmission 2000 changes to the desired rotational speed. Alternatively, a CVT (Continuously Variable Transmission) may be employed instead of an automatic transmission. In the CVT, the speed ratio is continuously changed. Additionally, an automatic transmission that includes a constant mesh gear, and that is operated by a hydraulic actuator may also be employed.

The output gear of the automatic transmission 2000 engages with the differential gear 5000. The differential gear 5000 is connected to a drive shaft 6000, for example, using a spline. Power is transmitted to the front right and front left wheels 7000 via the drive shaft 6000.

The ECU 8000 is connected to a coolant temperature sensor 8002, a position switch 8006 for a shift lever 8004, an accelerator-pedal operation amount sensor 8010 for an accelerator pedal 8008, a brake-pedal force sensor 8014 for a brake pedal 8012, a throttle-valve opening amount sensor 8018 for an electronic throttle valve 8016, an engine speed sensor 8020, an input-shaft rotational speed sensor 8022, an output-shaft rotational speed sensor 8024, and an oil temperature sensor 8026, for example, via harness.

The coolant temperature sensor 8002 detects the temperature of coolant for the engine 1000 (hereinafter, referred to as “coolant temperature”), and transmits a signal that indicates the detected coolant temperature to the ECU 8000. The position switch 8006 detects the position of the shift lever 8004, and transmits a signal that indicates the detected shift lever position to the ECU 8000. The gear is automatically selected in the automatic transmission 2000, according to the position of the shift lever 8004. A manual shift mode may also be selected. When the manual shift mode is selected, a driver may select any gear by manual operation.

The accelerator-pedal operation amount sensor 8010 detects the operation amount of the accelerator pedal 8008, and transmits a signal that indicates detected operation amount to the ECU 8000. The brake-pedal force sensor 8014 detects the force applied to the brake pedal 8012, and transmits a signal that indicates the detected force to the ECU 8000.

The throttle-valve opening amount sensor 8018 detects the opening amount of the electronic throttle valve 8016, and transmits a signal that indicates the detected opening amount to the ECU 8000. The opening amount of the electronic throttle valve 8016 is adjusted by an actuator. The electronic throttle valve 8016 adjusts the amount of air taken into the engine 1000.

The engine speed sensor 8020 detects the rotational speed of the crankshaft of the engine 1000, and transmits a signal that indicates the detected crankshaft speed to the ECU 8000. The input-shaft rotational speed sensor 8022 detects the rotational speed NI of the input shaft of the automatic transmission 2000 (i.e., the rotational speed NT of the turbine of the torque converter 3200), and transmits a signal that indicates the detected input shaft speed to the ECU 8000. The output-shaft rotational speed sensor 8024 detects the rotational speed NO of the output shaft of the automatic transmission 2000, and transmits a signal that indicates the detected output shaft speed to the ECU 8000.

The oil temperature sensor 8026 detects the temperature of automatic transmission fluid (ATF), used for operating and lubricating the automatic transmission 2000, and transmits the detected ATF temperature to the ECU 8000.

The ECU 8000 controls devices so that the vehicle moves in a desired state, based on the signals transmitted from the coolant sensor 8002, position switch 8006, accelerator-pedal operation amount sensor 8010, brake-pedal force sensor 8014, throttle-valve opening amount sensor 8018, engine speed sensor 8020, input-shaft rotational speed sensor 8022, output-shaft rotational speed sensor 8024, oil temperature sensor 8026, and the like, and maps and programs stored in the ROM (Read Only Memory).

In this embodiment, when the shift lever 8004 is at the position D (Drive), and accordingly the D (Drive) range is selected in the automatic transmission 2000, the ECU 8000 controls the automatic transmission 2000 so that one of a first gear to a sixth gear is selected. When one of the first gear to the sixth gear is selected, the automatic transmission 2000 transmits driving force to the front wheels 7000. In the D range, at least one higher gear than the sixth gear may be provided. That is, for example, a seventh gear and an eighth gear may be provided. The gear is selected based on a shift diagram that is made in advance, for example, empirically. In the shift diagram, the vehicle speed and accelerator-pedal operation amount are used as parameters.

As shown in FIG. 1, the ECU 8000 includes an engine ECU 8100 that controls the engine 1000, and an ECT (Electronic Controlled Automatic Transmission)_ECU 8200 that controls the automatic transmission 2000.

The engine ECU 8100 transmits/receives signals to/from the ECT_ECU 8200. In this embodiment, the engine ECU 8100 transmits the signal that indicates the accelerator-pedal operation amount and the signal that indicates the coolant temperature to the ECT_ECU 8200.

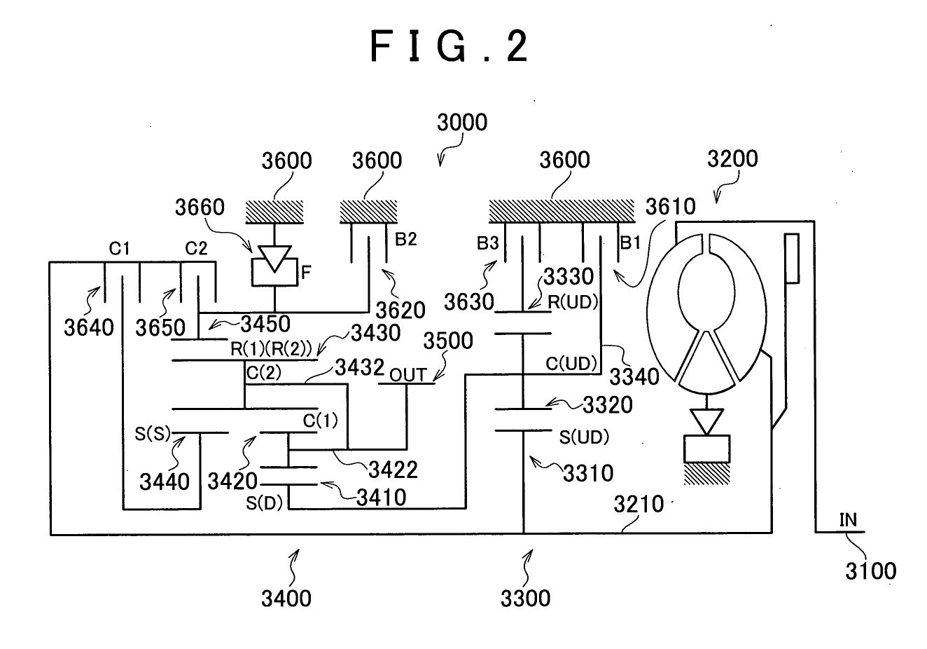

The planetary gear unit 3000 will be described with reference to FIG. 2. The planetary gear unit 3000 is connected to the torque converter 3200 that includes the input shaft 3100 connected to the crankshaft. The planetary gear unit 3000 includes a first set 3300 of planetary gear mechanism, a second set 3400 of planetary gear mechanism, an output gear 3500, a B1 brake 3610, a B2 brake 3620, and a B3 brake 3630, a C1 clutch 3640 and a C2 clutch 3650, and a one-way clutch F3660. The B1 brake 3610, B2 brake 3620, and B3 brake 3630 are fixed to the gear case 3600.

The first set 3300 is a single pinion type planetary gear mechanism. The first set 3300 includes a sun gear S (UD) 3310, a pinion 3320, a ring gear R (UD) 3330, and a carrier C (UD) 3340.

The sun gear S (UD) 3310 is connected to the output shaft 3210 of the torque converter 3200. The pinion 3320 is rotatably supported by the carrier C (UD) 3340. The pinion 3320 engages with the sun gear S (UD) 33 10 and ring gear R (UD) 3330.

The ring gear R (UD) 3330 is fixed to the gear case 3600 by the B3 brake 3630. The carrier C (UD) 3340 is fixed to the gear case 3600 by the B1 brake 3610.

The second set 3400 is a Ravigneaux type planetary gear mechanism. The second set 3400 includes a sun gear S (D) 3410, a short pinion 3420, a carrier C (1) 3422, a long pinion 3430, a carrier C (2) 3432, a sun gear S (S) 3440, and a ring gear R (1) (R (2)) 3450.

The sun gear S (D) 3410 is connected to the carrier C (UD) 3340. The short pinion 3420 is rotatably supported by the carrier C (1) 3422. The short pinion 3420 engages with the sun gear S (D) 3410, and long pinion 3430. The carrier C (1) 3422 is connected to the output gear 3500.

The long pinion 3430 is rotatably supported by the carrier C (2) 3432. The long pinion 3430 engages with the short pinion 3420, sun gear S (S) 3440, and ring gear R (1) (R (2)) 3450. The carrier C (2) 3432 is connected to the output gear 3500.

The sun gear S (S) 3440 is connected to the output shaft 3210 of the torque converter 3200 by the C1 clutch 3640. The ring gear R (1) (R (2)) 3450 is fixed to the gear case 3600 by the B2 brake 3620, and connected to the output shaft 3210 of the torque converter 3200 by the C2 clutch 3650. The ring gear R (1) (R (2)) 3450 is connected to the one-way clutch F3660. When the engine drives the wheels in the first gear, the ring gear R (1) (R (2)) 3450 is prevented from rotating.

The one-way clutch F3660 is provided in parallel with the B2 brake 3620. That is, the outer race of the one-way clutch F3660 is fixed to the gear case 3600. The inner race of the one-way clutch F3660 is connected to the ring gear R (1) (R (2)) 3450 via a rotation shaft.

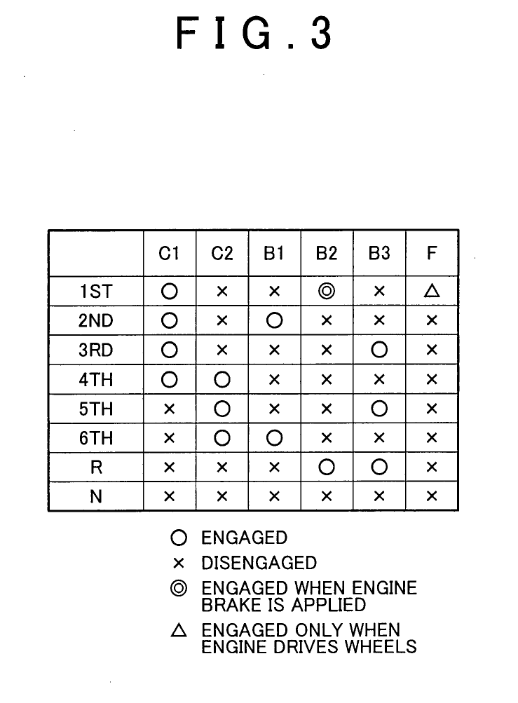

FIG. 3 is an operation table that shows the relation between the gears and the operating states of the clutches and brakes. By operating the brakes and clutches as shown in the operation table, one of the first gear to the sixth gear, and a reverse gear is selected.

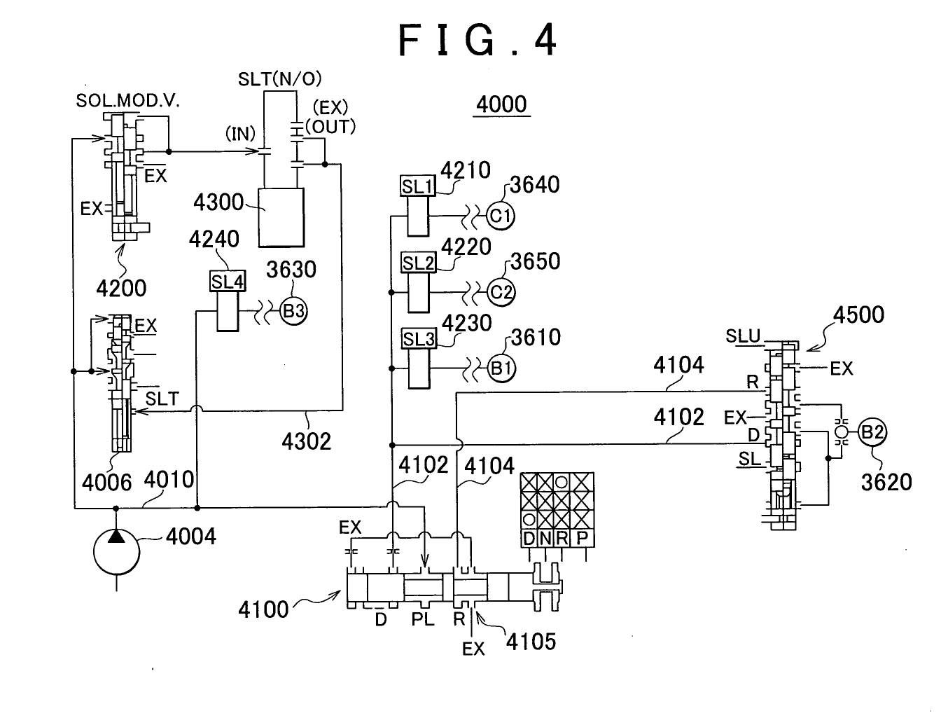

As shown in FIG. 4, the main part of the hydraulic circuit 4000 will be described. The hydraulic circuit 4000 is not limited to the circuit described below.

The hydraulic circuit 4000 includes an oil pump 4004, a primary regulator valve 4006, a manual valve 4100, a solenoid modulator valve 4200, an SL1 linear solenoid (hereinafter, simply referred to as SL (1)) 4210, an SL2 linear solenoid (hereinafter, simply referred to as SL (2)) 4220, an SL3 linear solenoid (hereinafter, simply referred to as SL (3)) 4230, an SL4 linear solenoid (hereinafter, simply referred to as SL (4)) 4240, an SLT linear solenoid (hereinafter, simply referred to as SLT) 4300, and a B2 control valve 4500.

The oil pump 4004 is connected to the crankshaft of the engine 1000. By rotating the crankshaft, the oil pump 4004 generates a hydraulic pressure. The primary regulator valve 4006 regulates the hydraulic pressure generated by the oil pump 4004, which is the source pressure, to a line pressure.

The primary regulator valve 4006 is operated by a throttle pressure that functions as a pilot pressure. The SLT 4300 regulates a solenoid modulator pressure to the throttle pressure, as described later. The line pressure is supplied to the manual valve 4100 via a line pressure oil passage 4010.

The manual valve 4100 includes a drain port 4105. The hydraulic pressure in a D-range pressure oil passage 4102 and the hydraulic pressure in an R-range pressure oil passage 4104 are discharged through the drain port 4105. When the spool of the manual valve 4100 is at the position D, communication is provided between the line pressure oil passage 4010 and the D-range pressure oil passage 4102, and thus, the hydraulic pressure is supplied to the D-range pressure oil passage 4102. At this time, communication is provided between the R-range pressure oil passage 4104 and the drain port 4105, and thus, the R-range pressure in the R-range pressure oil passage 4104 is discharged through the drain port 4105.

When the spool of the manual valve 4100 is at position R, communication is provided between the line pressure oil passage 4010 and the R-range pressure oil passage 4104, and thus, the hydraulic pressure is supplied to the R-range pressure oil passage 4104. At this time, communication is provided between the D-range pressure oil passage 4102 and the drain port 4105, and thus, the D-range pressure in the D-range pressure oil passage 4102 is discharged through the drain port 4105.

When the spool of the manual valve 4100 is at the position N, communication is provided between the D-range pressure oil passage 4102 and the drain port 4105, and between the R-range pressure oil passage 4104 and the drain port 4105. Thus, the D-range pressure in the D-range pressure oil passage 4102 and the R-range pressure in the R-range pressure oil passage 4104 are discharged through the drain port 4105.

The hydraulic pressure supplied to the D-range pressure oil passage 4102 is finally supplied to the B1 brake 3610, B2 brake 3620, C1 clutch 3640, and C2 clutch 3650. The hydraulic pressure supplied to the R-range pressure oil passage 4104 is finally supplied to the B2 brake 3620.

The solenoid modulator valve 4200 regulates the line pressure, which is the source pressure, to the constant solenoid modulator pressure to be supplied to the SLT 4300.

The SL (1) 4210 regulates a hydraulic pressure to be supplied to the C1 clutch 3640. The SL (2) 4220 regulates a hydraulic pressure to be supplied to the C2 clutch 3650. The SL (3) 4230 regulates a hydraulic pressure to be supplied to the B1 brake 3610. The SL (4) 4240 regulates a hydraulic pressure to be supplied to the B3 brake 3630.

The SLT 4300 regulates the solenoid modulator pressure, which is the source pressure, to the throttle pressure according to a control signal from the ECU 8000. The ECU 8000 transmits the control signal based on the accelerator-pedal operation amount detected by the accelerator-pedal operation amount sensor 8010. The throttle pressure is supplied to the primary regulator valve 4006 via an SLT oil passage 4302. The throttle pressure is used as the pilot pressure for the primary regulator valve 4006.

The SL (1) 4210, SL (2) 4220, SL (3) 4230, SL (4) 4240, and SLT 4300 are controlled by the control signals transmitted from the ECU 8000.

The B2 control valve 4500 selectively supplies the hydraulic pressure in the D-range pressure oil passage 4102 or the hydraulic pressure in the R-range pressure oil passage 4104 to the B2 brake 3620. The B2 control valve 4500 is connected to the D-range pressure oil passage 4102 and the R-range pressure oil passage 4104. The B2 control valve 4500 is controlled by the hydraulic pressure supplied from an SL solenoid valve (not shown) and the hydraulic pressure supplied from an SLU solenoid valve (not shown), and the impelling force of a spring.

When the SL solenoid valve is off, and the SLU solenoid valve is on, the B2 control valve 4500 is in the state as shown in the left half of the B2 control valve 4500 in FIG. 4. In this case, the B2 control valve 4500 is operated by the hydraulic pressure supplied from the SLU solenoid valve, which functions as the pilot pressure. Thus, the B2 control valve 4500 regulates the D-range pressure, and supplies the regulated D-range pressure to the B2 brake 3620.

When the SL solenoid valve is on, and the SLU solenoid valve is off, the B2 control valve 4500 is in the state as shown in the right half of the B2 control valve 4500 in FIG. 4. In this case, the B2 control valve 4500 supplies the R-range pressure to the B2 brake 3620.

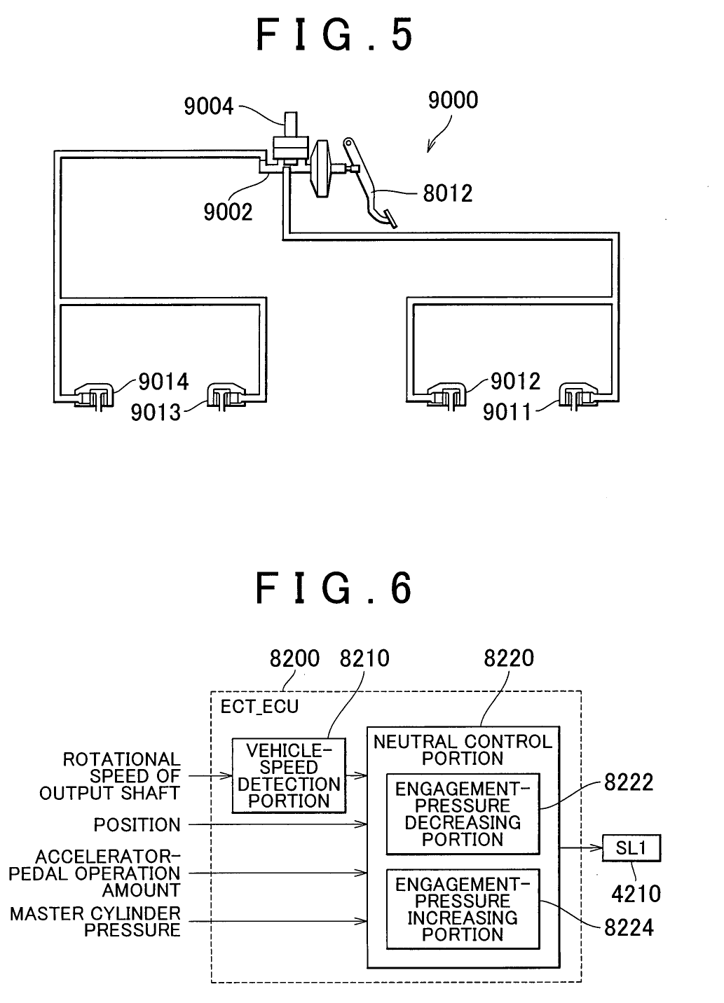

As shown in FIG. 5, a brake system 9000 will be described with reference to FIG. 5. The brake system 9000 generates a hydraulic pressure according to the force applied to the brake pedal 8012, or the amount by which the brake pedal 8012 is operated, and applies a braking force to the vehicle.

The brake pedal 8012 is connected to a master cylinder 9002. When the brake pedal 8012 is operated, the hydraulic pressure is generated in the master cylinder 9002 according to the force applied to the brake pedal 8012 or the amount by which the brake pedal 8012 is operated. A hydraulic pressure sensor 9004 detects the hydraulic pressure generated in the master cylinder 9002 (hereinafter, the hydraulic pressure will be sometimes referred to as “master cylinder pressure”), and transmits a signal that indicates the detected master cylinder pressure to the ECU 8000.

The master cylinder pressure is supplied to calipers 9011 to 9014 provided in the wheels. When the hydraulic pressure is supplied to the calipers 9011 to 9014, the braking force is applied to the vehicle.

The function of the ECT_ECU 8200 will be described with reference to FIG. 6. The function of the ECT_ECU 8200 may be implemented through hardware or software.

The ECT_ECU 8200 includes a vehicle-speed detection portion 8210 and a neutral control portion 8220. The vehicle-speed detection portion 8210 calculates (detects) the vehicle speed based on the rotational speed NO of the output shaft of the automatic transmission 2000.

The neutral control portion 8220 includes an engagement-pressure decreasing portion 8222, and an engagement-pressure increasing portion 8224. The neutral control portion 8220 executes a neutral control when a neutral control execution condition is satisfied. The neutral control execution condition may be satisfied when the shift lever 8004 is at one of forward-gear positions that include the position D, the accelerator-pedal operation amount is equal to or smaller than a predetermined amount, the master cylinder pressure is equal to or higher than a predetermined pressure, and the vehicle is stopped (i.e., the vehicle speed is “0”).

During the neutral control, the engagement-pressure decreasing portion 8222 controls the SL (1) 4210 to decrease the engagement pressure for the Cl clutch 3640 (i.e., the hydraulic pressure supplied to the hydraulic servo of the C1 clutch 3640). If the master cylinder pressure decreases during the neutral control, the engagement-pressure increasing portion 8224 controls the SL (1) 4210 to increase the engagement pressure for the C1 clutch 3640. Further, if the master cylinder pressure increases during the neutral control, the engagement-pressure decreasing portion 8222 controls the SL (1) 4210 to decrease the engagement pressure for the C1 clutch 3640.

During the neutral control, in addition to, or instead of changing the engagement pressure for the C1 clutch 3640, the engagement pressure for the other friction engagement element may be changed.

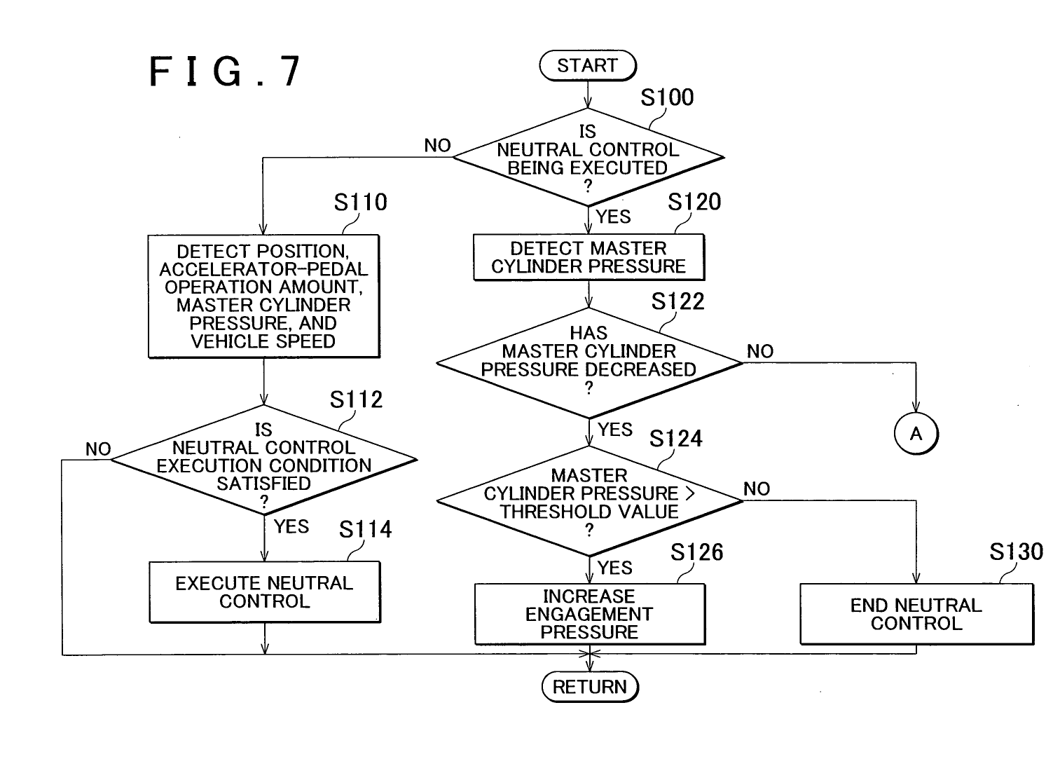

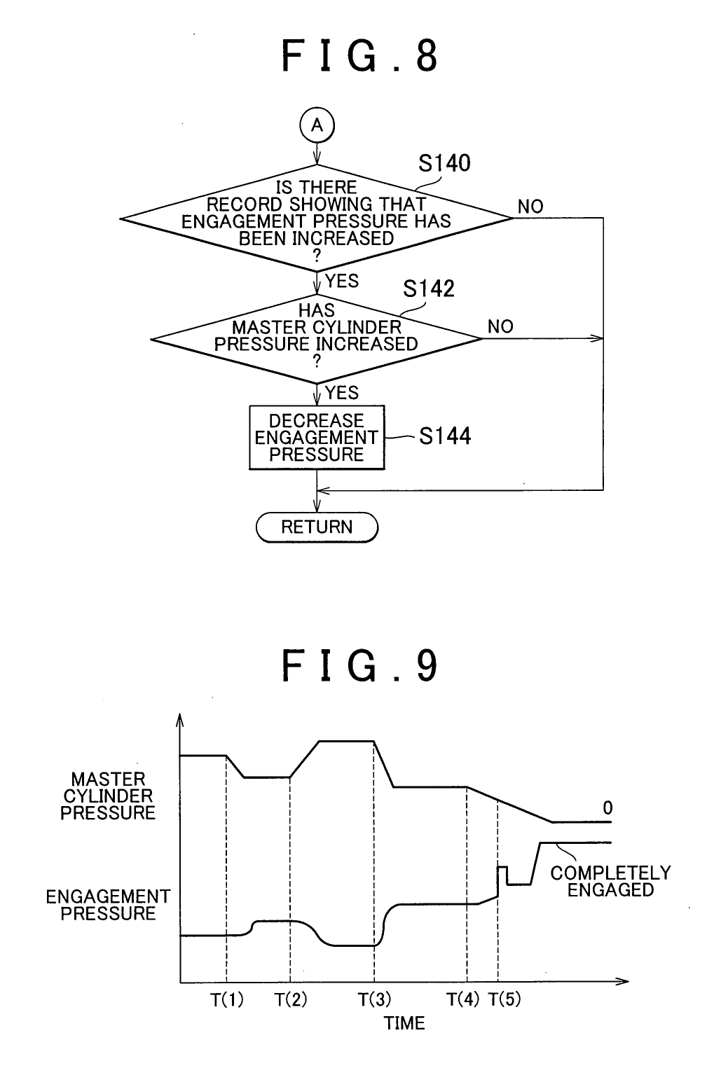

The control structure of the program executed by the ECT_ECU 8200, which is the control apparatus according to this embodiment, will be described with reference to FIG. 7 and FIG. 8. The program described below is periodically executed at predetermined intervals.

As shown in FIG. 7, in step S100, the ECT_ECU 8200 determines whether the neutral control is being executed. If the ECT_ECU 8200 determines that the neutral control is being executed (YES in step S100), the routine proceeds to step S120. If the ECT_ECU 8200 determines that the neutral control is not being executed (NO in step S100), the routine proceeds to step S110.

In step S110, the ECU_ECU 8200 detects the position of the shift lever 8004, accelerator-pedal operation amount, master cylinder pressure, and vehicle speed, based on the signals transmitted from the position switch 8006, accelerator-pedal operation amount sensor 8010, hydraulic pressure sensor 9004, and output-shaft rotational speed sensor 8024, respectively.

In step S112, the ECT_ECU 8200 determines whether the neutral control execution condition is satisfied. The neutral control execution condition may be satisfied when the shift lever 8004 is at one of the forward-gear positions, the accelerator-pedal operation amount is equal to or smaller than the predetermined amount, the master cylinder pressure is equal to or higher than the predetermined pressure, and the vehicle is stopped.

If the neutral control execution condition is satisfied (YES in step S112), the routine proceeds to step S114. If the neutral control execution condition is not satisfied (NO in step S112), the routine ends. In step S114, the ECT_ECU 8200 executes the neutral control. Then, the routine ends.

In step S120, the ECT_ECU 8200 detects the master cylinder pressure based on the signal transmitted from the hydraulic pressure sensor 9004.

In step S122, the ECT_ECU 8200 determines whether the master cylinder pressure has decreased after the previous execution of the program (i.e., whether the current master cylinder pressure is lower than the master cylinder pressure detected when the program was previously executed). If the ECT_ECU 8200 determines that the master cylinder pressure has decreased (YES in step S122), the routine proceeds to step S124. If the ECT_ECU 8200 determines that the master cylinder pressure has not decreased (NO in step S122), the routine proceeds to step S140 in FIG. 8.

In step S124 in FIG. 7, the ECT_ECU 8200 determines whether the master cylinder pressure is higher than a threshold value. The threshold value is used to determine whether the neutral control needs to end. If the ECT_ECU 8200 determines that the master cylinder pressure is higher than the threshold value for ending the neutral control (YES in step S124), the routine proceeds to step S126. If the ECT_ECU 8200 determines that the master cylinder pressure is equal to or lower than the threshold value for ending the neutral control (NO in step S124), the routine proceeds to step S130.

In step S126, the ECT_ECU 8200 increases the engagement pressure for the C1 clutch 3640 according to the amount by which the master cylinder pressure has decreased (i.e., the difference between the current master cylinder pressure and the master cylinder pressure detected when the program is executed last time).

In step S130, the ETC_ECU 8200 ends the neutral control. That is, the engagement pressure for the C1 clutch 3640 increases until the C1 clutch 3640 is completely engaged.

As shown in FIG. 8, in step S140, the ECT_ECU 8200 determines whether there is a record showing that the engagement pressure for the C1 clutch 3640 has been increased after the neutral control starts. If the ECT_ECU 8200 determines that there is the record showing that the engagement pressure for the C1 clutch 3640 has been increased (YES in step S140), the routine proceeds to step S142. If the ECT_ECU8200 determines that there is no record (NO in step S140), the routine ends.

In step S142, the ECT_ECU 8200 determines whether the master cylinder pressure has increased after the previous execution of the program (i.e., whether the current master cylinder pressure is higher than the master cylinder pressure detected when the program was previously executed). If the master cylinder pressure has increased (YES in step S142), the routine proceeds to step S144. If the master cylinder pressure has not increased (NO in step S142), the routine ends. That is, the current engagement pressure is maintained.

In step S144, the ECT_ECU 8200 decreases the engagement pressure for the C1 clutch 3640 according to the amount by which the master cylinder pressure has increased (i.e., the difference between the current master cylinder pressure and the master cylinder pressure detected when the program was previously executed). Then, the routine ends.

The operation of the ECT_ECU 8200 based on the above-described structure and flowchart will be described. The ECT_ECU 8200 is the control apparatus according to this embodiment.

When the vehicle is moving, and the neutral control is not being executed (NO in step S100), the position of the shift lever 8004, accelerator-operation amount, master cylinder, and vehicle speed are detected (S110). When the neutral control execution condition is satisfied (YES in step S112), the neutral control is executed (S114).

When the neutral control is being executed (YES in step S100), the master cylinder pressure is detected (S120). When the master cylinder pressure decreases, that is, the amount by which the brake pedal 8012 is operated by the driver (hereinafter, referred to as “brake operation amount”) decreases at time T (1) in FIG. 9 during the neutral control (YES in step S122), the vehicle may start from a stop.

When the master cylinder pressure is higher than the threshold value for ending the neutral control (YES in step S124), the engagement pressure for the C1 clutch 3640 is increased according to the amount by which the master cylinder pressure has decreased (S126).

If there is the record showing that the engagement pressure for the C1 clutch 3640 has been increased during the neutral control (YES in step S140), and the master cylinder pressure (i.e., the brake operation amount), which has decreased, increases at time T (2) in FIG. 9 (YES in step S142), there is a low possibility that the vehicle will start. In this case, the engagement pressure for the C1 clutch 3640 is decreased according to the amount by which the master cylinder pressure has increased (S144).

If the master cylinder pressure decreases again at time point T (3) in FIG. 9 (YES in step S122), and the master cylinder pressure is higher than the threshold value for ending the neutral control (YES in step S124), the engagement pressure for the C1 clutch 3640 is increased according to the amount by which the master cylinder pressure has decreased (S126).

When the master cylinder pressure decreases at time point T (4) in FIG. 9 (YES in step S122), and the master cylinder pressure is equal to or lower than the threshold value for ending the neutral control (NO in step S124), it is regarded that the driver releases the brake pedal 8012 to start the vehicle.

In this case, the neutral control ends (S130). That is, the engagement pressure for the C1 clutch 3640 is increased until the C1 clutch 3640 is completely engaged. As described above, the engagement pressure for the C1 clutch 3640 has been increased before the neutral control ends. Therefore, the engagement pressure need not be quickly increased to quickly restart the normal control when the neutral control ends. This decreases an engagement shock when the neutral control ends.

As described above, when the master cylinder pressure decreases during the neutral control, the ECT_ECU 8200 increases the engagement pressure for the C1 clutch 3640, which has been decreased by the neutral control. Thus, the engagement pressure for the C1 clutch is increased before the neutral control ends. Therefore, the engagement pressure need not be quickly increased to quickly restart the normal control when the neutral control ends. This decreases the engagement shock when the neutral control ends.

Hereinafter, a second embodiment of the invention will be described. The second embodiment differs from the first embodiment in that the engagement pressure for the C1 clutch is decreased when the elapsed time after the decrease in the master cylinder pressure exceeds a predetermined time during the neutral control.

The configurations other than the function of the ECT_ECU 8200 and the flowchart are the same as those in the first embodiment. The functions of the components other than the ECT_ECU 8200 are the same as those in the first embodiment. Thus, the detailed description thereof will be omitted.

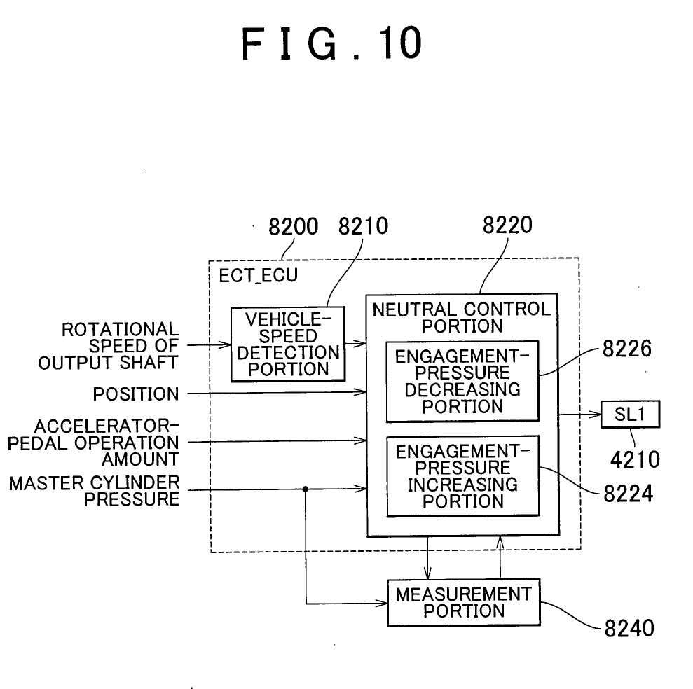

The function of the ECT_ECU 8200 according to the embodiment will be described with reference to FIG. 10. The function of the ECT_ECU 8200 may be implemented through hardware or software.

The ECT_ECU 8200 includes the vehicle-speed detection portion 8210, the neutral control portion 8220, and a measurement portion 8240.

The vehicle-speed detection portion 8210 is the same as that in the first embodiment. The neutral control portion 8220 includes an engagement-pressure decreasing portion 8226, and the engagement-pressure increasing portion 8224. As in the first embodiment, the neutral control portion 8220 executes the neutral control when the neutral control execution condition is satisfied.

As in the first embodiment, during the neutral control, the engagement-pressure decreasing portion 8226 controls the SL (1) 4210 to decrease the engagement pressure for the C1 clutch 3640.

As in the first embodiment, when the master cylinder pressure decreases during the neutral control, the engagement-pressure increasing portion 8224 controls the SL (1) 4210 to increase the engagement pressure for the C1 clutch 3640.

Unlike the first embodiment, when the elapsed time after the decrease in the master cylinder pressure exceeds the predetermined time during the neutral control, the engagement-pressure decreasing portion 8226 controls the SL (1) 4210 to decrease the engagement pressure for the C1 clutch 3640.

The measurement portion 8240 measures the elapsed time after the decrease in the master cylinder pressure during the neutral control. During the neutral control, instead of, or in addition to changing the engagement pressure for the C1 clutch 3640, the engagement pressure for the other friction engagement element may be changed.

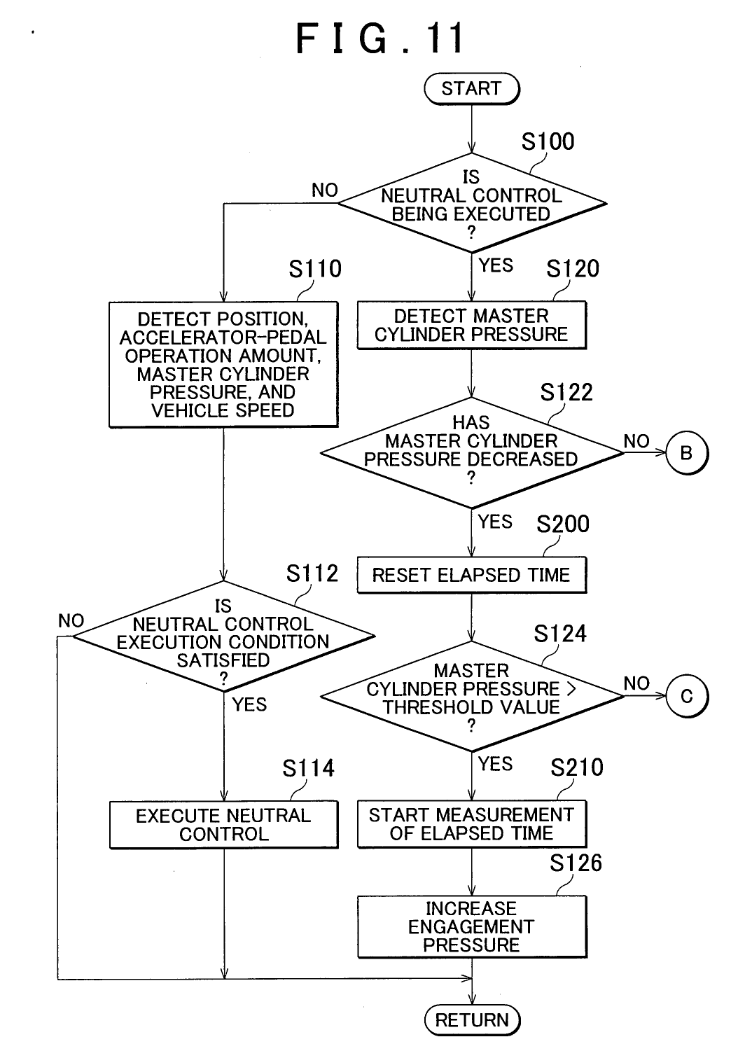

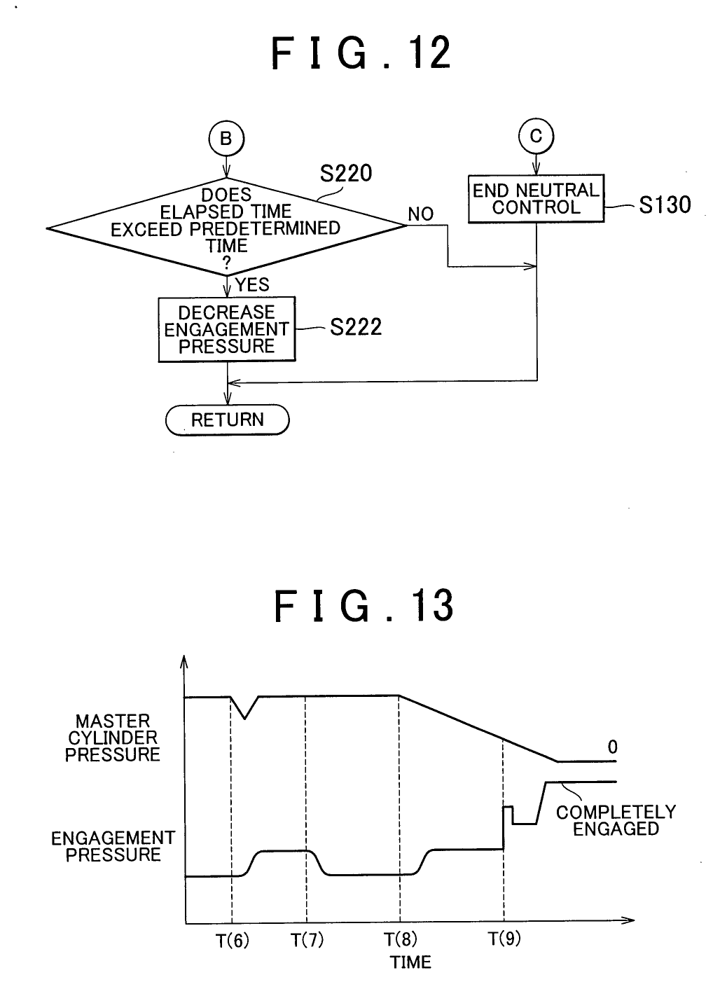

The control structure of the program executed by the ECT_ECU 8200 will be described with reference to FIG. 11 and FIG. 12. The ECT_ECU 8200 is the control apparatus according to this embodiment. The program described below is repeatedly executed at predetermined time intervals. The same processes as in the first embodiment are denoted by the same step numbers, and the detailed description thereof will be omitted.

As shown in FIG. 11, in step S200, the ECT_ECU 8200 resets the elapsed time after the decrease in the master cylinder pressure. That is, the elapsed time is set to “0”. In step S210, the ECT_ECU 8200 starts to measure the elapsed time after the decrease in the master cylinder pressure.

As shown in FIG. 12, in step S220, the ECT_ECU 8200 determines whether the elapsed time after the decrease in the master cylinder pressure exceeds the predetermined time. If the elapsed time exceeds the predetermined time (YES in step S220), the routine proceeds to step S222. If the elapsed time does not exceed the predetermined time (NO in step S220), the routine ends.

In step S222, the ECT_ECU 8200 decreases the engagement pressure for the C1 clutch 3640. For example, the ECT_ECU 8200 decreases the engagement pressure for the C1 to offset the increase in the engagement pressure due to the decrease in the master cylinder pressure.

The operation of the ECT_ECU 8200 based on the above-described structure and flowchart will be described. The ECT_ECU 8200 is the control apparatus according to this embodiment.

When the vehicle is moving, and the ECT_ECU 8200 determines that the neutral control is not being executed (NO in step S100), the position of the shift lever 8004, accelerator-pedal operation amount, master cylinder pressure and vehicle speed are detected (S110). If the neutral control execution condition is satisfied (YES in step S112), the neutral control is executed (S114).

When the neutral control is being executed (YES in step S100), the master cylinder pressure is detected (S120). If the master cylinder pressure (i.e., brake operation amount) decreases at time T (6) in FIG. 13 during the neutral control (YES in step S122), the ECT_ECU 8200 resets the elapsed time after the decrease in the master cylinder pressure (S200).

If the master cylinder pressure is higher than the threshold value for ending the neutral control (YES in step S124), the ECT_ECU 8200 starts the measurement of the elapsed time after the decrease in the master cylinder pressure (S210). Further, the engagement pressure for the C1 clutch 3640 is increased according to the amount by which the master cylinder pressure has decreased (S126).

When the neutral control is being executed (YES in step S100), and the master cylinder pressure has not decreased (NO in step S122), and the elapsed time after the decrease in the master cylinder pressure exceeds the predetermined time at time T (7) in FIG. 13 (YES in step S220), there is a low possibility that the vehicle will start. In this case, the engagement pressure for the C1 clutch 3640 is decreased (S222).

This decreases the driving force transmitted to the front wheels 7000 via the automatic transmission. Therefore, the loss of energy is decreased. As a result, the deterioration of fuel efficiency is suppressed.

When the master cylinder pressure decreases again at time T (8) in FIG. 13 (YES in step S122), and the master cylinder pressure is higher than the threshold value for ending the neutral control (YES in step S124), the engagement pressure for the C1 clutch 3640 is increased according to the amount by which the master cylinder pressure has decreased (S126).

When the master cylinder pressure is equal to or lower than the threshold value for ending the neutral control at time T (9) in FIG. 13 (NO in step S124), it is regarded that the driver releases the brake pedal 8012 to start the vehicle.

In this case, the neutral control ends (S130). That is, the engagement pressure for the C1 clutch 3640 is increased until the C1 clutch 3640 is completely engaged. As described above, the engagement pressure has been increased before the neutral control ends. Therefore, the engagement pressure need not be quickly increased to quickly restart the normal control when the neutral control ends. This decreases the engagement shock when the neutral control ends.

As described above, when the elapsed time after the decrease in the master cylinder pressure exceeds the predetermined time, the engagement pressure, which has been increased, is decreased again. This decreases the driving force to be transmitted to the front wheels via the automatic transmission. Therefore, the loss of energy is decreased. As a result, the deterioration of fuel efficiency is suppressed.

Hereinafter, a third embodiment of the invention will be described. The third embodiment differs from the first embodiment in that the engagement pressure for the C1 clutch is gradually increased when an elapsed time after start of the neutral control exceeds a predetermined time.

The configurations other than the function of the ECT_ECU 8200 and the flowchart are the same as those in the first embodiment. The functions of the components other than the ECT_ECU 8200 are the same as those in the first embodiment. Thus, the detailed description thereof will be omitted.

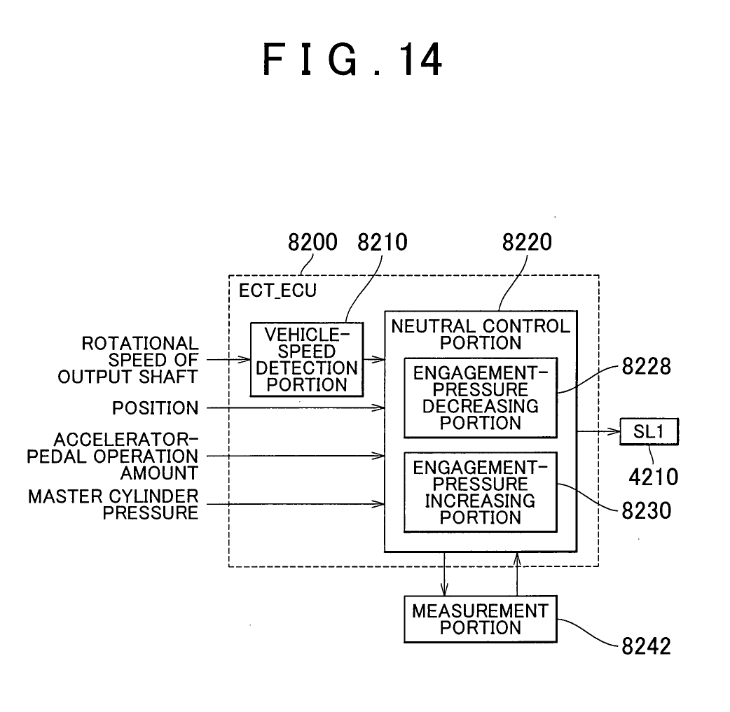

The function of the ECT_ECU 8200 in this embodiment will be described with reference to FIG. 14. The function of the ECT_ECU 8200 described below may be implemented through hardware or software.

The ECT_ECU 8200 includes the vehicle-speed detection portion 8210, the neutral control portion 8220, and a measurement portion 8242.

The vehicle-speed detection portion 8210 is the same as that in the first embodiment. As in the first embodiment, the neutral control portion 8220 executes the neutral control when the neutral control execution condition is satisfied.

As in the first embodiment, during the neutral control, the engagement-pressure decreasing portion 8228 controls the SL (1) 4210 to decrease the engagement pressure for the C1 clutch 3640.

Unlike the first embodiment, when the elapsed time after the start of the neutral control exceeds the predetermined time, the engagement-pressure increasing portion 8230 controls the SL (1) 4210 to gradually increase the engagement pressure for the C1 clutch 3640.

The measurement portion 8242 measures the elapsed time after the start of the neutral control. During the neutral control, instead of, or in addition to changing the engagement pressure for the C1 clutch 3640, the engagement pressure for the other friction engagement element may be changed.

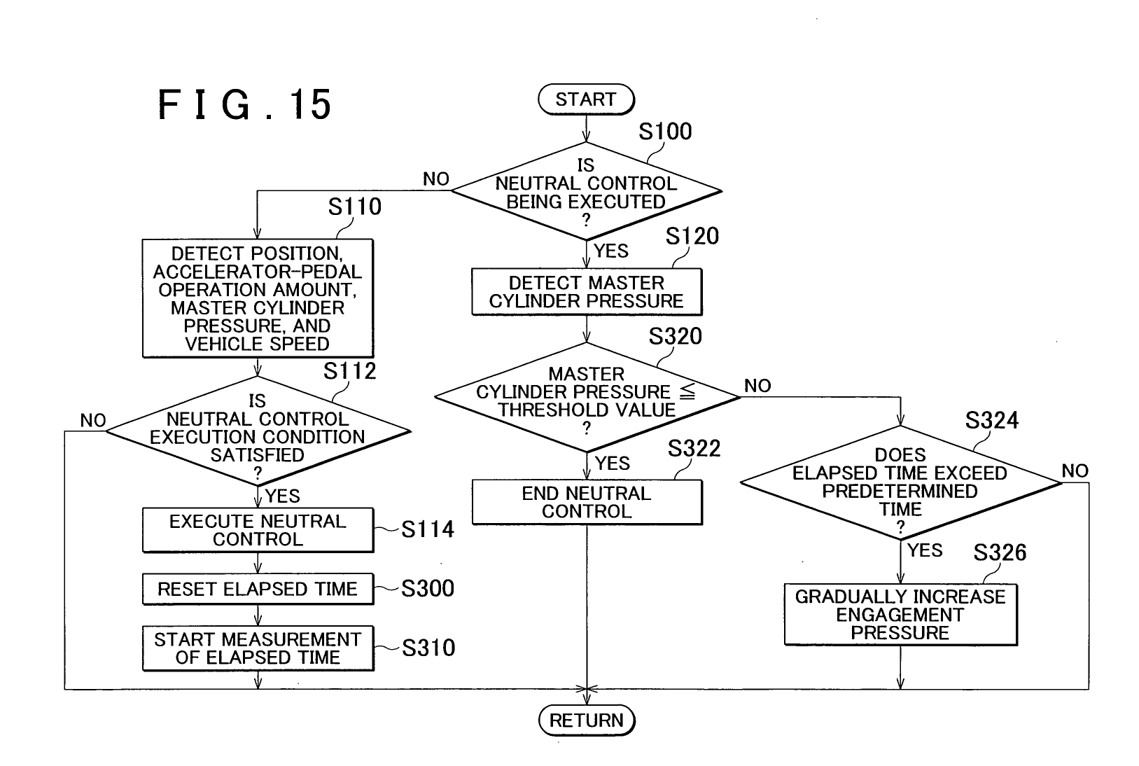

The control structure of the program executed by the ECT_ECU 8200 will be described with reference to FIG. 15. The ECT_ECU 8200 is the control apparatus according to this embodiment. The program described below is repeatedly executed in predetermined time intervals. The same processes as in the first embodiment are denoted by the same step numbers, and the detailed description thereof will be omitted.

In step S300, the ECT_ECU 8200 resets the elapsed time after the start of the neutral control. That is, the elapsed time is set to “0”. In step S310, the ECT_ECU8200 starts the measurement of the elapsed time after the start of the neutral control.

In step S320, the ECT_ECU 8200 determines whether the master cylinder pressure is equal to or lower than the threshold value for ending the neutral control. If the master cylinder pressure is equal to or lower than the threshold value for ending the neutral control (YES in step S320), the routine proceeds to step S322. If the master cylinder pressure is higher than the threshold value for ending the neutral control (NO in step S320), the routine proceeds to step S324. In step S322, the ECT_ECU 8200 ends the neutral control.

In step S324, the ECT_ECU 8200 determines whether the elapsed time after the start of the neutral control exceeds the predetermined time. If the ECT_ECU 8200 determines that the elapsed time exceeds the predetermined time (YES in step S324), the routine proceeds to step S326. If the ECT_ECU 8200 determines that the elapsed time does not exceed the predetermined time (NO in step S324), the routine ends. In step S326, the ECT_ECU 8200 gradually increases the engagement pressure for the C1 clutch 3640.

The operation of the ECT_ECU 8200 based on the above-described structure and flowchart will be described.

When the vehicle is moving, and the neutral control is not being executed (NO in step S100), the position of the shift lever 8004, accelerator-pedal operation amount, master cylinder pressure, and vehicle speed are detected (S110).

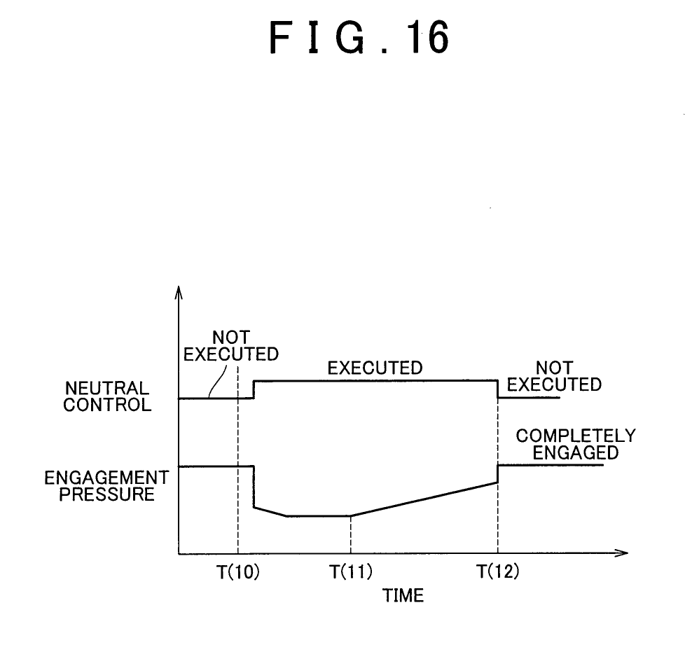

When the neutral control execution condition is satisfied at time T (10) in FIG. 16 (YES in step S112), the neutral control is executed (S114). When the neutral control is executed, the ECT_ECU 8200 resets the elapsed time after the start of the neutral control (S300). In addition, the ECT_ECU 8200 starts the measurement of the elapsed time after the start of the neutral control (S310).

When the neutral control is being executed (YES in step S100), the master cylinder pressure is detected (S120). When the master cylinder pressure is equal to or higher than the threshold value for ending the neutral control (NO in step S320), it is determined whether the elapsed time after the start of the neutral control exceeds the predetermined time (S324).

When the elapsed time does not exceed the predetermined time (NO in step S324), the current engagement pressure is maintained. When the elapsed time exceeds the predetermined time (YES in step S324), the engagement pressure for the C1 clutch 3640 is gradually increased (S326).

When the master cylinder pressure is equal to or lower than the threshold value for ending the neutral control at time T (12) in FIG. 16 (YES in step S320), the neutral control ends (S322). That is, the engagement pressure for the C1 clutch 3640 is increased until the C1 clutch 3640 is completely engaged.

As described above, the engagement pressure for the C1 clutch 3640 has been increased before the neutral control ends. Therefore, the engagement pressure need not be quickly increased to quickly restart the normal control when the neutral control ends. This decreases the engagement shock when the neutral control ends.

As described above, when the elapsed time after the start of the neutral control exceeds the predetermined time, the ECT_ECU 8200 gradually increases the engagement pressure for the C1 clutch that has been decreased by the neutral control. Thus, the engagement pressure for the C1 clutch is increased before the neutral control ends. Therefore, the engagement pressure need not be quickly increased to quickly restart the normal control when the neutral control ends. This decreases the engagement shock when the neutral control ends.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

What is claimed is:

1. A control apparatus for a vehicular automatic transmission, comprising:
a detector that detects a brake operation amount by which a brake of a vehicle is operated;
a controller that executes a neutral control to decrease an engagement pressure for a friction engagement element of the automatic transmission, when a shift lever is in a forward gear position, an accelerator pedal is not operated, the brake is operated, and the vehicle is stopped, wherein the controller increases the engagement pressure for the friction engagement element when the brake operation amount detected by the detector decreases during the neutral control.

2. The control apparatus for a vehicular automatic transmission according to claim 1, wherein as the detected brake operation amount decreases, the controller increases the engagement pressure for the friction engagement element.

3. The control apparatus for a vehicular automatic transmission according to claim 1, wherein when the detected brake operation amount increases during the neutral control, the controller decreases the engagement pressure for the friction engagement element.

4. The control apparatus for a vehicular automatic transmission according to claim 3, wherein as the detected brake operation amount increases, the controller decreases the engagement pressure for the friction engagement element.

5. The control apparatus for a vehicular automatic transmission according to claim 1, wherein when a predetermined time has elapsed after the detected brake operation amount decreases during the neutral control, the controller decreases the engagement pressure for the friction engagement element.

6. A control apparatus for a vehicular automatic transmission, comprising:
a controller that executes a neutral control to decrease an engagement pressure for a friction engagement element of the automatic transmission, when a shift lever is in a forward gear position, an accelerator pedal is not operated, a brake of a vehicle is operated, and the vehicle is stopped; and
a measurement device that measures an elapsed time after start of the neutral control, wherein the controller increases the engagement pressure for the friction engagement element during the neutral control when the measured elapsed time after start of the neutral control exceeds a predetermined time.

7. The control apparatus for a vehicular automatic transmission according to claim 6, wherein as the measured elapsed time increases during the neutral control, the controller increases the engagement pressure for the friction engagement element.

8. A method of controlling a vehicular automatic transmission, comprising:
detecting a brake operation amount by which a brake of a vehicle is operated during a neutral control;
executing the neutral control to decrease an engagement pressure for a friction engagement element of the automatic transmission, when a shift lever is in a forward gear position, an accelerator pedal is not operated, the brake is operated, and the vehicle is stopped; and
increasing the engagement pressure for the friction engagement element when the detected brake operation amount decreases during the neutral control.

9. The method of controlling a vehicular automatic transmission according to claim 8, wherein as the brake operation amount decreases, the engagement pressure for the friction engagement element is increased.

10. The method of controlling a vehicular automatic transmission according to claim 8, further comprising
decreasing the engagement pressure for the friction engagement element when the detected brake operation amount increases during the neutral control.

11. The method of controlling a vehicular automatic transmission according to claim 10, wherein as the detected brake operation amount increases, the engagement pressure for the friction engagement element is decreased.

12. The method of controlling a vehicular automatic transmission according to claim 8, further comprising
decreasing the engagement pressure for the friction engagement element when a predetermined time has elapsed after the detected brake operation amount decreases during the neutral control.

13. A method of controlling a vehicular automatic transmission, comprising:
executing a neutral control to decrease an engagement pressure for a friction engagement element of the automatic transmission, when a shift lever is in a forward gear position, an accelerator pedal is not operated, a brake of a vehicle is operated, and the vehicle is stopped;
measuring an elapsed time after start of the neutral control; and
increasing the engagement pressure for the friction engagement element during the neutral control when the measured elapsed time after start of the neutral control exceeds a predetermined time.

14. The method of controlling a vehicular automatic transmission according to claim 13, wherein as the measured elapsed time increases during the neutral control, the engagement pressure for the friction engagement element is increased.
